(19) United States
(12) Patent Application Publication
(10) Pub. No.: US 2005/0053063 A1
(43) Pub. Date: Mar. 10, 2005

(54) Automatic provisioning of network address translation data

(76) Inventor: Sajeev Madhavan, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/656,041

(22) Filed: Sep. 4, 2003

(51) Int. Cl. H04L 12/26

(52) U.S. Cl. 370/389; 709/245; 709/230

(57) ABSTRACT

A method for automatically generating network address translation (NAT) data to enable a private host having a private IP address to communicate with a public host having a first public IP address. The method includes providing automated NAT provision software which, responsive to a message initiated by one of the private host and the public host, consults a security policy associated with the private host to determine whether the communication between the private host and the public host is permissible. The method further includes provisioning automatically using the software and without a human operator intervention after the consulting, if the consulting indicates that the communication between the private host and the public host is permissible, in a database a second public IP address for address translation between the private IP address and the second public IP address.

### BACKGROUND OF THE INVENTION

IP addresses have long been employed to route communication between hosts via the public network, e.g., the Internet. Public IP addresses are addresses that can be understood and employed by switching devices in the public network to route information between communicating hosts. Private IP addresses, on the other hand, are addresses associated with hosts connected in a private network. These private IP addresses enable the routing of information within the private network but they are not usable for routing through the public network, e.g., to facilitate communication between a private host and an external host that resides in the public network. Private hosts are typically connected to the internet via a firewall, which serves, among other functions, to keep private network addresses from exposure to the public network.

To facilitate discussion, FIG. 1 shows a plurality of private hosts 102, 104 and 106 representing, for example, computers and/or other devices interconnected in a private network 108. Each of private hosts 102, 104, and 106 has a private IP address, shown as private IP address 10.0.1.2, 10.0.1.3, and 10.0.1.4 respectively for routing information within private network 108. Private network 108 includes a firewall 110, representing the device for implementing security and controlling access between devices associated with private network 108 and a public network 112.

FIG. 1 further shows public hosts 114 and 116, representing in this example devices connected to the public network 112 and known to the public network 112 and other devices connected to public network 112 (such as private hosts 102, 104, and 106 via firewall 110) by respective public IP addresses 200.10.1.1 and 200.10.1.2. Unlike the private IP addresses associated with private hosts 102, 104, and 106, each of these public IP addresses may be employed by public network 112 to route information to any other device that is coupled to public network 112 and that has a pubic IP address.

The communication to and from a private host, such as private host 102, 104, or 106, may be governed by a security policy. Generally speaking, a security policy dictates the restrictions in access and services, if any, a private host is subjected to. Access list is one way to implement a security policy.

FIG. 2 shows an example of an access list 202 in which access list entry # 1 permits Telnet service between public host 114 (public IP address 200.10.1.1) and private host 102 (private IP address 10.0.1.2). Access list entry # 2 permits HTTP service between private host 104 (private IP address 10.0.1.3) and public host 114 (public IP address 200.10.1.1). Access list entry #3 implements a generic policy, permitting any host within private network 108 to communicate with any public host connected to public network 112 for FTP service. Although only three examples are shown, an access list may implement any security policy, whether generic to all private hosts or specific to one or more private hosts, to permit access to any public host or set of public hosts for any service or set of services.

As mentioned, private IP addresses are not usable for routing information via the public network. Accordingly, a private host's private IP address needs to be translated to a public IP address, typically by the firewall, in order for communication to take place between a private host and an public host, i.e., one connected to the public network and known to the public network by a pubic IP address. Such translation is known as Network Address Translation or NAT. Typically, a firewall is configured with NAT data in order to perform the required address translation to enable communication between a private host and a public host, if such communication is permitted by the applicable security policy or policies.

In the prior art, the NAT data is manually configured by the administrator. When a private host is initially connected to the private network and initialized, a security policy may be created for that private host or that private host may be subject to an existing generic security policy. If the private host is allowed to communicate with any public host, the administrator must manually provision the NAT data by selecting a public IP address from the pool of available public IP addresses, and must manually associate that public IP address with the new private host's private IP address so that future NAT can be performed.

The association between a private host's private IP address and a public IP address for external communication purposes is typically accomplished by administrator 120 of FIG. 1 via the manual creation of one or more entries in a NAT table, such as NAT table 302 of FIG. 3. In the example of FIG. 3, private host 102 (private IP address 10.0.1.2) is associated with a translated public IP address 210.0.0.1, and private host 104 (private IP address 10.0.1.3) is associated with a translated public IP address 210.0.0.2. By consulting access table 202 of FIG. 2 and NAT table 302 of FIG. 3, firewall 110 can ascertain whether a private host is permitted to access a given public host for a given service, and can perform the required NAT translation if such access is permitted.

There are, however, disadvantages associated with the prior art technique of firewall configuration, particularly with respect to the provisioning of the NAT data. For example, the manual approach is error prone, e.g., the human operator can mistype an IP address while creating an entry in the NAT table, thereby causing a security violation. Additionally, the involvement of the human administrator in the manual provisioning of NAT data inevitably involves delay, disadvantageously prolonging the time required to bring a private host up to operational status.

### SUMMARY OF INVENTION

The invention relates, in one embodiment, to a method for automatically generating network address translation (NAT) data to enable a private host having a private IP address to communicate with a public host having a first public IP address. The private host is connected to a private network. The public host is connected to a public network. The method includes providing automated NAT provision software, the software, responsive to a message initiated by one of the private host and the public host, consulting a security policy associated with the private host to determine whether the communication between the private host and the public host is permissible. The method further includes provisioning automatically using the software and without a human operator intervention after the consulting, if the consulting indicates that the communication between the private host and the public host is permissible, in a database a second public IP address for address translation between the private IP address and the second public IP address. The second public IP address is employed as one of a source IP address and a destination IP address for routing the communication between the private host and the public host through the public network.

In another embodiment, the invention relates to an article of manufacture comprising a program storage medium having computer readable code embodied therein. The computer readable code is configured to automatically generate network address translation (NAT) data to enable a private host having a private IP address to communicate with a public host having a first public IP address. The private host is connected to a private network. The public host is connected to a public network. There is included computer readable code for providing automated NAT provision software. The software consults, responsive to a message initiated by one of the private host and the public host, a security policy associated with the private host to determine whether communication between the private host and the public host is permissible. There is further included computer readable code for automatically provisioning, in a database using the software without human intervention after the consulting, a second public IP address for address translation between the private IP address and the second public IP address. The second public IP address is employed as one of a source IP address and a destination IP address for routing the communication between the private host and the public host through the public network, the automatically provisioning being performed if the consulting indicates that the communication between the private host and the public host is permissible.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a plurality of private hosts representing, for example, computers and/or other devices interconnected in a private network to facilitate discussion.

FIG. 2 shows an example of an access list.

FIG. 3 shows an example of a Network Address Translation (NAT) table.

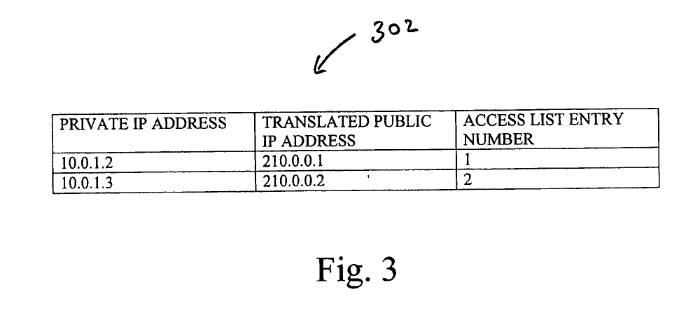

FIG. 4 illustrates, in accordance with one embodiment of the present invention, the exemplary network of FIG. 1 except that the firewall is now provided with the automatic NAT provisioning software driver.

FIG. 5 illustrates, in accordance with one embodiment of the present invention, the method implemented by the automatic NAT provisioning software driver.

FIG. 6 illustrates, in accordance with one embodiment of the present invention, the steps taken by the automatic NAT provisioning software driver when a private host is removed from the private network.

### DETAILED DESCRIPTION OF PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In one embodiment, there is provided software (code and/or firmware) with the firewall for automatically and dynamically configuring the NAT data responsive to events such as the addition of a private host to the private network, the deletion of a private host from the private network, and/or the initiation of communication involving the private host. In one embodiment, the software driver checks the access list to ascertain the security policy concerning a private host for which IP address translation may be required, and automatically configures the NAT table based on the security policy ascertained. Intelligence is built into the software to handle situations where multiple policies apply to the private host at issue, to ascertain whether a dedicated public IP address is required depending on whether the communication is inbound or outbound, and to automatically remove a NAT entry when the private host associated with that NAT entry is removed from the private network.

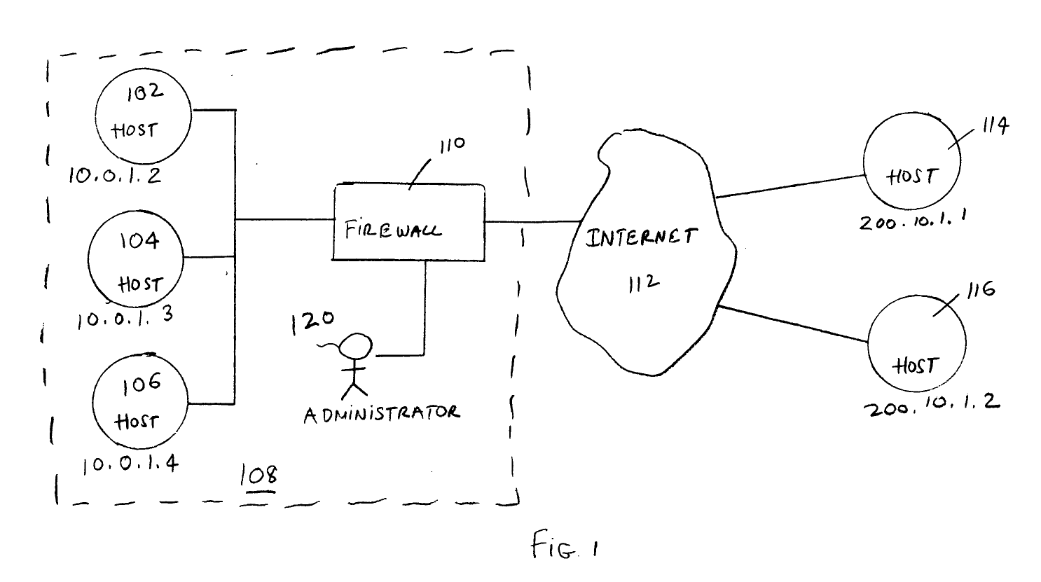

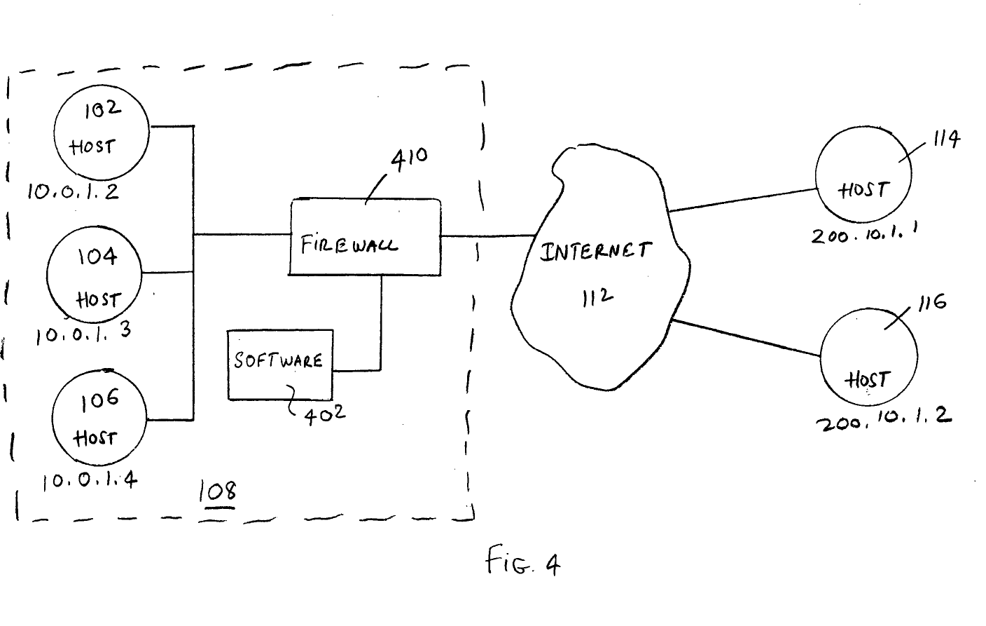

The features and advantages of the present invention may be better understood with reference to the figures and discussion that follow. FIG. 4 illustrates, in accordance with one embodiment of the present invention, the exemplary network of FIG. 1 except that firewall 410 is now provided with automatic NAT provisioning software driver 402. In contrast to FIG. 1, the provisioning of the NAT data to the firewall for use in facilitating communication to and from the private hosts is now automatically performed by automatic NAT provisioning software 402. As such, disadvantages associated with the prior art manual provisioning technique are advantageously eliminated.

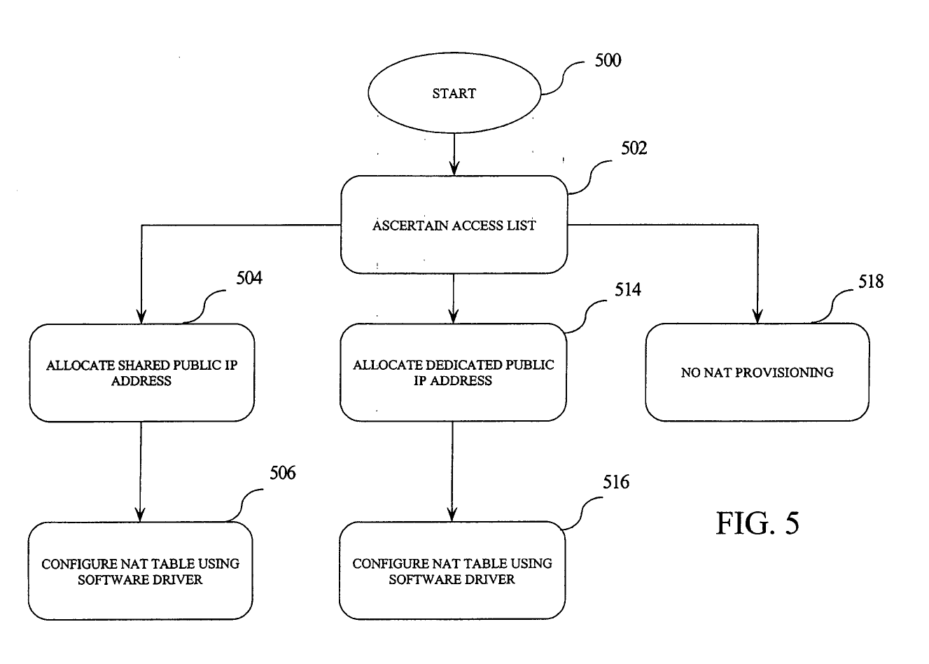

FIG. 5 illustrates, in accordance with one embodiment of the present invention, the method implemented by software driver 402. The steps of FIG. 5 are typically performed during run time when there is a change to the access list, e.g., when there is an addition or deletion of a private host or when there is a change in a security policy that affects one or more of the private hosts. In one embodiment, the access list may be automatically updated in the firewall by auto-discovery software, which automatically detects the topology of the private network and/or the addition/deletion of a device from the private network, including the identity of the device being added/deleted.

In one embodiment, the allocation of a public IP address happens only when communication is initiated (either public to private or private to public). In this manner, the pool of public IP address available to the private network remains free as much as possible, and a public IP address is only allocated when actual communication is about to take place.

In step 502, the access list is consulted to ascertain, for a private host, whether the communication is permissible. The communication may be outbound (i.e., initiated by the private host for communicating with a public host), inbound (i.e., initiated by the public host for communicating with the private host) or private-to-private (i.e., from one private host to another private host).

If the communication is outbound and is permissible according the access list, a shared public IP address is allocated (step 504) and the software configure the NAT table (506) to permit the firewall to translate the private IP address of the private host to a public address for the purpose of allowing communication between the private host and the public host to take place via the public network. Note that in this case, the use of a shared public IP address is possible since the public host would be able to ascertain, from the communication initiated by the private host, the shared public IP address to use in sending information back to the private host.

If the communication is inbound and is permissible according the access list, a dedicated public IP address is allocated (step 514) and the software configure the NAT table (step 516) to permit the firewall to translate the private IP address of the private host to a public address for the purpose of allowing communication between the private host and the public host to take place via the public network. Note that in this case, a dedicated public IP address is employed since the public host, being the initiator, only knows the private host by the dedicated public IP address.

On the other hand, if the communication is private-to-private and permissible according to the access list, no translation is required and thus no action is taken with respect to provisioning the NAT table (step 518).

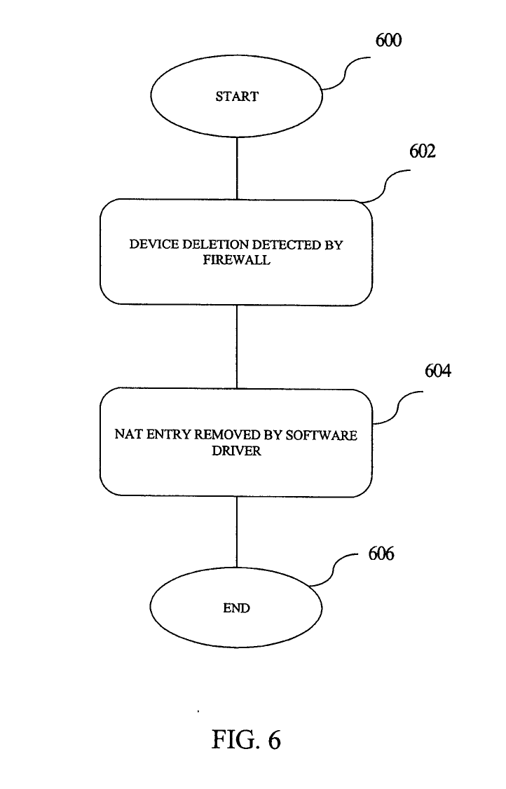

FIG. 6 illustrates, in accordance with one embodiment of the present invention, the steps taken by software driver 402 when a private host is removed from the private network. As mentioned, the removal of a private host from the private network may be automatically ascertained (602) by, for example, an auto-discovery mechanism or via some other notification mechanism. In step 604, the NAT entry associated with the removed private host is removed from the NAT table.

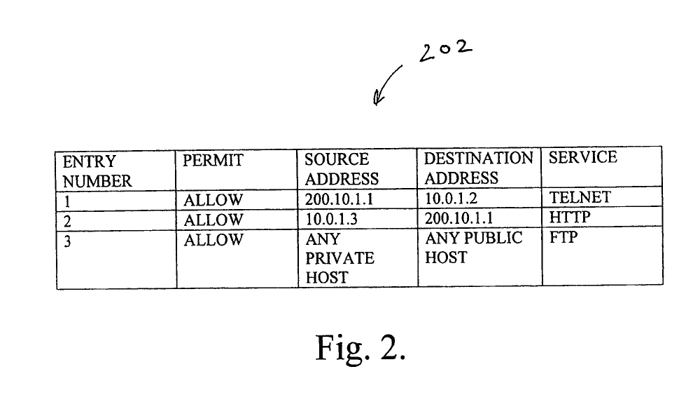

The invention is particularly well-suited to handle generic security policies. A generic security policy may be defined as a security policy that applies to a private host based on factors other than the specific identity of the private host. Access list entry #3 in FIG. 2 is one such example, wherein the factor is the type of service (FTP in this case). Thus, according to access list entry #3, any private host, irrespective of its specific private IP address, may perform FTP service with any public host.

In the case of a generic policy, the software may be configured to provision the NAT table for the affected private host only when needed. In contrast to the prior art wherein the administrator must manually configure a NAT entry for each of the affected private host whenever there exists a generic policy, the invention advantageously eliminates this labor-intensive step. With respect to the generic policy of access list entry #3 in FIG. 2, for example, the creation of such a policy would have meant that the administrator would, in the prior art, need to manually create a large number of NAT entries to allow each private host connected to the private network to employ the FTP service with a public host.

With the present invention, the allocation of an allocated public IP address is only performed when the FTP service requested, either by the private host or by the public host. Efficiency is enhanced since the allocation does not require human involvement and therefore does not suffer from human-induced errors. Furthermore, the software-implemented NAT provisioning occurs automatically and at computer speed, which is substantially faster than can be manually performed by a human administrator. Additionally, allocated public IP addresses are not wasted since the allocation may only happen when communication is about to begin.

In case of generic policy like the access list entry #3 in FIG. 2, NAT entries would be automatically generated for all the devices to which the generic policy applies in the Private Subnet. NAT entries are preferably generated before communication is about to begin, i.e., before the access list on the firewall is configured.

It should be noted that during the allocation step 504 and 514, the software is intelligent enough to ascertain whether the private host has already been allocated a public IP address, e.g., by consulting the existing NAT table. For example, there may be two security policies affecting a single private host. In that case, the allocation only happens once, i.e., the software does not allocate two different public IP addresses to the private host in that case.

As can be appreciated from the foregoing, the invention advantageously eliminates the potential human-induced errors associated with the prior art manual NAT provisioning technique. Furthermore, the automatic provisioning of the NAT data at computer speed based on, e.g., a change in the security policy and/or a change in the access list and/or a notification from the auto-discovery mechanism or from other notification mechanisms regarding private host addition/deletion, substantially shortens the time required to update the NAT data for accurate communication routing.

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. A method for automatically generating network address translation (NAT) data to enable a private host having a private IP address to communicate with a public host having a first public IP address, said private host being connected to a private network, said public host being connected to a public network, comprising:
providing automated NAT provision software, said software, responsive to communication initiated by one of said private host and said public host, consulting a security policy associated with said private host to determine whether said communication between said private host and said public host is permissible; and
if said consulting indicates that said communication between said private host and said public host is permissible, provisioning automatically using said software and without a human operator intervention after said consulting, in a database a second public IP address for address translation between said private IP address and said second public IP address, said second public IP address being employed as one of a source IP address and a destination IP address for routing said communication between said private host and said public host through said public network.

2. The method of claim 1 wherein said security policy is implemented using an access list.

3. The method of claim 2 wherein said second public IP address represents a shared public IP address if said communication is initiated by said private host.

4. The method of claim 2 wherein said second public IP address represents a dedicated public IP address if said communication is initiated by said public host.

5. The method of claim 1 wherein said database represents a Network Address Translation (NAT) table.

6. The method of claim 1 further including:
detecting a removal of said private host from said private network; and
removing, using said software, said second public IP address from said database responsive to said detecting said removal of said private host.

7. The method of claim 1 wherein said security policy represents a generic security policy.

8. The method of claim 7 further comprising automatically generating NAT data for all private hosts affected by said generic policy after said generic policy is modified using said software.

9. An article of manufacture comprising a program storage medium having computer readable code embodied therein, said computer readable code being configured to automatically generate network address translation (NAT) data to enable a private host having a private IP address to communicate with a public host having a first public IP address, said private host being connected to a private network, said public host being connected to a public network, comprising:
computer readable code for providing automated NAT provision software, said software consulting a security policy associated with said private host to determine whether communication between said private host and said public host is permissible; and
computer readable code for provisioning, in a database using said software, if said consulting indicates that said communication between said private host and said public host is permissible, a second public IP address for address translation between said private IP address and said second public IP address, said second public IP address being employed as one of a source IP address and a destination IP address for routing said communication between said private host and said public host through said public network.

10. The article of manufacture of claim 9 wherein said security policy is implemented using an access list.

11. The article of manufacture of claim 10 wherein said second public IP address represents a shared public IP address if said communication is initiated by said private host.

12. The article of manufacture of claim 10 wherein said second public IP address represents a dedicated public IP address if said communication is initiated by said public host.

13. The article of manufacture of claim 9 wherein said database represents a Network Address Translation (NAT) table.

14. The article of manufacture of claim 9 further including:
computer readable code for detecting a removal of said private host from said private network; and
computer readable code for removing, using said software, said second public IP address from said database responsive to said detecting said removal of said private host.

15. The article of manufacture of claim 9 wherein said security policy represents a generic security policy.

16. The article of manufacture of claim 15 further comprising computer readable code for automatically generating NAT data for all private hosts affected by said generic policy after said generic policy is modified using said software.

17. A method for automatically generating network address translation (NAT) data in a NAT table to enable communication between a private host having a private IP address and a public host having a first public IP address, said private host being connected to a private network, said public host being connected to a public network, comprising:
consulting, using automated NAT provision software, a security policy associated with said private host to determine whether said communication between said private host and said public host is permissible, said consulting being performed responsive to a message initiated by one of said private host and said public host; and
if said consulting indicates that said communication between said private host and said public host is permissible, provisioning automatically using said software and without a human operator intervention after said consulting, in said NAT table a second public IP address for address translation between said private IP address and said second public IP address, said second public IP address being employed as one of a source IP address and a destination IP address for routing said communication between said private host and said public host through said public network.

18. The method of claim 17 wherein said second public IP address represents a shared public IP address if said communication is initiated by said private host.

19. The method of claim 17 wherein said second public IP address represents a dedicated public IP address if said communication is initiated by said public host.
